(19) United States
(12) Patent Application Publication
(10) Pub. No.: US 2004/0213477 A1
(43) Pub. Date: Oct. 28, 2004

(54) Image-processing method and apparatus, computer program for executing image processing and image-recording apparatus

(75) Inventors: Takeshi Nakajima, Tokyo (JP); Tsukasa Ito, Tokyo (JP); Kouji Miyawaki, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc., Tokyo (JP)

(21) Appl. No.: 10/824,278

(22) Filed: Apr. 14, 2004

(30) Foreign Application Priority Data
Apr. 23, 2003 (JP) JP2003-118555

(51) Int. Cl. G06K 9/00

(52) U.S. Cl. 382/254

(57) ABSTRACT

There is described an image-processing method for applying a predetermined image processing to image signals, to output processed image signals. The method includes the steps of: applying a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and applying a second processing for decreasing the signal intensity deviation or keeping the signal intensity deviation as it is to a second-objective pixel, which is included in objective pixels having a spatial frequency in a range of 0.7-3.0 lines/mm, and whose signal intensity deviation is in a range of 0-6% of the maximum signal intensity deviation. The first processing includes a sharpness-enhancement processing, while the second processing includes a noise-reduction processing.

### BACKGROUND OF THE INVENTION

The present invention relates to image-processing method and apparatus, a computer program for executing an image processing and an image-recording apparatus.

In recent years, in the Mini-Lab (small-scale developing site), etc., the image formed on the color film has been converted to the digital image signals by photo-electronically reading the image with the CCD (Charge Coupled Device) sensor, etc., equipped in the film scanner. Various kinds of image processing, represented by the negative/positive inversion processing, the luminance adjustment processing, the color balance adjustment processing, the granularity eliminating processing and the sharpness enhancing processing, are applied to such the image signals read by the film scanner, and then, the processed image signals are distributed to the viewers by means of the storage medium, such as a CD-R, a floppy (Registered Trade Mark) disk, a memory card, etc. or through the Internet. Each of the viewers would view the hard-copy image printed by anyone of an ink-jetting printer, a thermal printer, etc., or the image displayed on one of various kinds of display devices including a CRT (Cathode Ray Tube), a liquid-crystal display device, a plasma display device, etc., based on the distributed image signals. Further, in recent years, a less costly digital still camera (hereinafter abbreviated as “DSC”) has come into widespread use. The DSC incorporated in such equipment as a cellular phone and laptop PC is also extensively used.

On the other hand, generally speaking, the images captured by a fixed focus camera such as a compact camera, etc., and a lens-fitted film unit, or captured in a darkish environment under a room light or in the nighttime, are apt to be out of focus and blurred. Further, since the DSC employs an image sensor having a relatively small number of pixels and a cheaper lens, and its focal distance is short due to the minimization of the DSC, the images captured by such the DSC are also apt to be blurred.

To solve the abovementioned problem, it is necessary to apply a sharpness-enhancement processing more strongly than usual. Generally speaking, a method of adding edge components extracted by using an acknowledged high-pass filter, such as a Laplacian filter, a Sobel filter, a Huckel filter, etc., a method of using an unsharp mask, etc., can be employed as the method for conducting the sharpness-enhancement processing (for instance, refer to Non-Patent Document 1).

[Non-Patent Document 1]

“Practical Image Processing learnt in C-language”, by Seiki Inoue, Nobuyuki Yagi, Masaki Hayashi, Hidesuke Nakasu, Kinji Mitani and Masato Okui, Ohm Publishing Co., Ltd.

Generally speaking, however, the image on the color film is formed by gathering dye-clouds having various sizes. Accordingly, when the image formed on the color film is enlarged for observation, mottled granular irregularity becomes visible corresponding to the sizes of dye-clouds, at an area where a color pattern should be inherently uniform. Owing to this fact, the image signals, acquired by photo-electronically reading the image formed on a photographic film with the CCD sensor or the like, includes granular noises corresponding to the mottled granular irregularity. It has bee a problem that the abovementioned granular noises considerably increase, especially associated with the image processing for enhancing the sharpness of the image, and deteriorate the image quality.

Further, the image sensor used in a less-costly DSC is characterized by a small pixel pitch. Shot noise tends to be produced at a low sensitivity, and not much consideration is given to cooling of an image sensor, so that conspicuous dark current noise is produced. The CMOS image sensor is often adopted in the less-costly DSC, so leakage current noise is conspicuous. When such noise is further subjected to image processing of interpolation of color filter arrangement and edge enhancement, the mottled granular irregularities are formed. It has been a problem that such the mottled granular irregularities would increase associating with the sharpness-enhancement processing, resulting in a deterioration of the image quality (for DSC noise and interpolation of color film arrangement, refer to, for instance, “Digital Photography” Chapter 2 and 3, published by The Society of Photographic Science and Technology of Japan, Corona Publishing Co., Ltd.).

### SUMMARY OF THE INVENTION

To overcome the abovementioned drawbacks in conventional image-processing method and apparatus, it is an object of the present invention to provide an image-processing method, which makes it possible to improve the sharpness property of the image without deteriorating the image quality caused by the granularity of the image.

Accordingly, to overcome the cited shortcomings, the abovementioned object of the present invention can be attained by image-processing method and apparatus, computer programs and image-recording apparatus described as follow.

(1) An image-processing method for applying a predetermined image processing to image signals, representing a plurality of pixels included in an image, so as to output processed image signals, comprising the steps of: applying a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and applying a second processing for decreasing the signal intensity deviation or keeping the signal intensity deviation as it is to a second-objective pixel, which is included in objective pixels having a spatial frequency in a range of 0.7-3.0 lines/mm, and whose signal intensity deviation is in a range of 0-6% of the maximum signal intensity deviation.

(2) The image-processing method of item 1, wherein the first processing includes a sharpness-enhancement processing, while the second processing includes a noise-reduction processing.

(3) The image-processing method of item 1, wherein the first processing multiplies the signal intensity deviation of the first-objective pixel by a factor in a range of 1.1-1.5.

(4) The image-processing method of item 1, wherein the second processing multiplies the signal intensity deviation of the second-objective pixel by a factor in a range of 0-0.75.

(5) The image-processing method of item 1, further comprising the step of: converting objective image signals, representing the objective pixels, to luminance signals and color-difference signals; wherein the first processing is applied to the luminance signals in the step of applying the first processing, while the second processing is applied to the color-difference signals in the step of applying the second processing.

(6) An image-processing apparatus for applying a predetermined image processing to image signals, representing a plurality of pixels included in an image, so as to output processed image signals, comprising: a first processing section to apply a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and a second processing section to apply a second processing for decreasing the signal intensity deviation or keeping the signal intensity deviation as it is to a second-objective pixel, which is included in objective pixels having a spatial frequency in a range of 0.7-3.0 lines/mm, and whose signal intensity deviation is in a range of 0-6% of the maximum signal intensity deviation.

(7) The image-processing apparatus of item 6, wherein the first processing includes a sharpness-enhancement processing, while the second processing includes a noise-reduction processing.

(8) The image-processing apparatus of item 6, wherein the first processing section multiplies the signal intensity deviation of the first-objective pixel by a factor in a range of 1.1-1.5.

(9) The image-processing apparatus of item 6, wherein the second processing section multiplies the signal intensity deviation of the second-objective pixel by a factor in a range of 0-0.75.

(10) The image-processing apparatus of item 6, further comprising: a converting section to convert objective image signals, representing the objective pixels, to luminance signals and color-difference signals; wherein the first processing section applies the first processing to the luminance signals, while the second processing section applies the second processing to the color-difference signals.

(11) A computer program for executing operations for applying a predetermined image processing to image signals, representing a plurality of pixels included in an image, so as to output processed image signals, comprising the functional steps of: applying a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and applying a second processing for decreasing the signal intensity deviation or keeping the signal intensity deviation as it is to a second-objective pixel, which is included in objective pixels having a spatial frequency in a range of 0.7-3.0 lines/mm, and whose signal intensity deviation is in a range of 0-6% of the maximum signal intensity deviation.

(12) The computer program of item 11, wherein the first processing includes a sharpness-enhancement processing, while the second processing includes a noise-reduction processing.

(13) The computer program of item 11, wherein the first processing multiplies the signal intensity deviation of the first-objective pixel by a factor in a range of 1.1-1.5.

(14) The computer program of item 11, wherein the second processing multiplies the signal intensity deviation of the second-objective pixel by a factor in a range of 0-0.75.

(15) The computer program of item 11, further comprising the functional step of: converting objective image signals, representing the objective pixels, to luminance signals and color-difference signals; wherein the first processing is applied to the luminance signals in the functional step of applying the first processing, while the second processing is applied to the color-difference signals in the functional step of applying the second processing.

(16) An image-recording apparatus, comprising: an image-processing section to apply a predetermined image processing to image signals, representing a plurality of pixels included in an input image, so as to output processed image signals; and an image-recording section to record an output image onto a recording medium, based on the processed image signals outputted by the image-processing section; wherein the image-processing section comprises: a first processing section to apply a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and a second processing section to apply a second processing for decreasing the signal intensity deviation or keeping the signal intensity deviation as it is to a second-objective pixel, which is included in objective pixels having a spatial frequency in a range of 0.7-3.0 lines/mm, and whose signal intensity deviation is in a range of 0-6% of the maximum signal intensity deviation.

(17) The image-recording apparatus of item 16, wherein the first processing includes a sharpness-enhancement processing, while the second processing includes a noise-reduction processing.

(18) The image-recording apparatus of item 16, wherein the first processing section multiplies the signal intensity deviation of the first-objective pixel by a factor in a range of 1.1-1.5.

(19) The image-recording apparatus of item 16, wherein the second processing section multiplies the signal intensity deviation of the second-objective pixel by a factor in a range of 0-0.75.

(20) The image-recording apparatus of item 16, wherein the image-processing section further comprises: a converting section to convert objective image signals, representing the objective pixels, to luminance signals and color-difference signals; and wherein the first processing section applies the first processing to the luminance signals, while the second processing section applies the second processing to the color-difference signals.

Further, to overcome the abovementioned problems, other image-processing methods and apparatus, computer programs and image-recording apparatus, embodied in the present invention, will be described as follow:

(21) An image-processing method, characterized in that,

in the image-processing method for applying a predetermined image processing to image signals and outputting,

among image signals as image-processing objects, a processing for increasing a signal intensity deviation is applied to a pixel, whose signal intensity deviation is in a range of 30-60% of a maximum signal intensity deviation, a spatial frequency in a range of 1.5-3.0 lines/mm, while a processing for decreasing a signal intensity deviation or keeping it unchanged is applied to a pixel, whose signal intensity deviation is in a range of 0-6% of a maximum signal intensity deviation, a spatial frequency in a range of 0.7-3.0 lines/mm.

(22) The image-processing method, described in item 21, characterized in that

a processing for multiplying the signal intensity deviation by a factor in a range of 1.1-1.5 is applied to the pixel, whose signal intensity deviation is in a range of 30-60% of a maximum signal intensity deviation, a spatial frequency in a range of 1.5-3.0 lines/mm.

(23) The image-processing method, described in item 21 or 22, characterized in that

a processing for multiplying the signal intensity deviation by a factor in a range of 0-0.75 is applied to the pixel, whose signal intensity deviation is in a range of 0-6% of a maximum signal intensity deviation, a spatial frequency in a range of 0.7-3.0 lines/mm.

(24) The image-processing method, described in anyone of items 21-23, characterized in that

the image signals as the image-processing objects are converted to luminance signals and color-difference signals, and the predetermined image processing is applied to the luminance signals.

(25) An image-processing apparatus, characterized in that,

in the image-processing apparatus for applying a predetermined image processing to image signals and outputting, there are provided

a first image-processing section to apply a processing for increasing a signal intensity deviation to a pixel, whose signal intensity deviation is in a range of 30-60% of a maximum signal intensity deviation, a spatial frequency in a range of 1.5-3.0 lines/mm, among image signals as image-processing objects, and

a second image-processing section to apply a processing for decreasing a signal intensity deviation or keeping it unchanged to a pixel, whose signal intensity deviation is in a range of 0-6% of a maximum signal intensity deviation, a spatial frequency in a range of 0.7-3.0 lines/mm.

(26) The image-processing apparatus, described in item 25, characterized in that

the first image-processing section applies a processing for multiplying the signal intensity deviation by a factor in a range of 1.1-1.5 to the pixel, whose signal intensity deviation is in a range of 30-60% of a maximum signal intensity deviation, a spatial frequency in a range of 1.5-3.0 lines/mm.

(27) The image-processing apparatus, described in item 25 or 26, characterized in that

the second image-processing section applies a processing for multiplying the signal intensity deviation by a factor in a range of 0-0.75 to the pixel, whose signal intensity deviation is in a range of 0-6% of a maximum signal intensity deviation, a spatial frequency in a range of 0.7-3.0 lines/mm.

(28) The image-processing apparatus, described in item anyone of 25-27, characterized in that the image-processing apparatus is provided with

a converting section to convert the image signals as the image-processing objects to luminance signals and color-difference signals, and

the first processing section applies the processing for increasing the signal intensity deviation to the luminance signals, while the second processing section applies the processing for decreasing the signal intensity deviation or keeping it unchanged to the color-difference signals.

(29) An image-processing program for computer, realizing the functions of:

a first image-processing function for applying a processing for increasing a signal intensity deviation to a pixel, whose signal intensity deviation is in a range of 30-60% of a maximum signal intensity deviation, a spatial frequency in a range of 1.5-3.0 lines/mm, among image signals as image-processing objects, and

a second image-processing function for applying a processing for decreasing a signal intensity deviation or keeping it unchanged to a pixel, whose signal intensity deviation is in a range of 0-6% of a maximum signal intensity deviation, a spatial frequency in a range of 0.7-3.0 lines/mm.

(30) The image-processing program, described in item 29, characterized in that,

when realizing the first image-processing function, a processing for multiplying the signal intensity deviation by a factor in a range of 1.1-1.5 is applied to the pixel, whose signal intensity deviation is in a range of 30-60% of a maximum signal intensity deviation, a spatial frequency in a range of 1.5-3.0 lines/mm.

(31) The image-processing program, described in item 29 or 30, characterized in that

when realizing the second image-processing function, a processing for multiplying the signal intensity deviation by a factor in a range of 0-0.75 is applied to the pixel, whose signal intensity deviation is in a range of 0-6% of a maximum signal intensity deviation, a spatial frequency in a range of 0.7-3.0 lines/mm.

(32) The image-processing program, described in item anyone of 29-31, characterized in that,

a converting function for converting the image signals as the image-processing objects to luminance signals and color-difference signals, and

when realizing the first image-processing function, the processing for increasing the signal intensity deviation is applied to the luminance signals, while, when realizing the second image-processing function, the processing for decreasing the signal intensity deviation or keeping it unchanged is applied to the color-difference signals.

(33) An image-recording apparatus, characterized in that,

in the image-processing apparatus, which is provided with image-recording section for applying a predetermined image processing to image signals to record onto an outputting medium, there are provided

a first image-processing section to apply a processing for increasing a signal intensity deviation to a pixel, whose signal intensity deviation is in a range of 30-60% of a maximum signal intensity deviation, a spatial frequency in a range of 1.5-3.0 lines/mm, among image signals as image-processing objects, and

a second image-processing section to apply a processing for decreasing a signal intensity deviation or keeping it unchanged to a pixel, whose signal intensity deviation is in a range of 0-6% of a maximum signal intensity deviation, a spatial frequency in a range of 0.7-3.0 lines/mm.

(34) The image-recording apparatus, described in item 33, characterized in that

the first image-processing section applies a processing for multiplying the signal intensity deviation by a factor in a range of 1.1-1.5 to the pixel, whose signal intensity deviation is in a range of 30-60% of a maximum signal intensity deviation, a spatial frequency in a range of 1.5-3.0 lines/mm.

(35) The image-recording apparatus, described in item 33 or 34, characterized in that

the second image-processing section applies a processing for multiplying the signal intensity deviation by a factor in a range of 0-0.75 to the pixel, whose signal intensity deviation is in a range of 0-6% of a maximum signal intensity deviation, a spatial frequency in a range of 0.7-3.0 lines/mm.

(36) The image-recording apparatus, described in item anyone of 33-35, characterized in that the image-recording apparatus is provided with

a converting section to convert the image signals as the image-processing objects to luminance signals and color-difference signals, and

the first processing section applies the processing for increasing the signal intensity deviation to the luminance signals, while the second processing section applies the processing for decreasing the signal intensity deviation or keeping it unchanged to the color-difference signals.

For instance, when the objective image signals are constituted by the primary three colors of RGB, each of RGB signal intensity deviations of the objective pixel would be increased or decreased. Sometimes, this operation would cause a color registration shift, depending on the RGB signal values of the pixel. Accordingly, to prevent such the color registration shift, it is desirable that the objective image signals are converted to the luminance signals and the color-difference signals, and then, the processing is applied to the luminance signals.

According to the present invention, since the first processing for increasing a signal intensity deviation is applied to a first-objective pixel, which is included in objective pixels having a spatial frequency in a range of 1.5-3.0 lines/mm, and whose signal intensity deviation is in a range of 30-60% of a maximum signal intensity deviation, while a second processing, for decreasing the signal intensity deviation or keeping the signal intensity deviation as it is, is applied to a second-objective pixel, which is included in objective pixels having a spatial frequency in a range of 0.7-3.0 lines/mm, and whose signal intensity deviation is in a range of 0-6% of the maximum signal intensity deviation, it becomes possible to suppress the granularity of the reproduced image, while improving the sharpness property of it.

Next, the terminology employed in the present invention will be detailed in the following.

The term of “spatial frequency”, defined in the present invention, represents a spatial frequency of an image outputted onto anyone of a photographic paper, a hard-copy material, a displaying device, etc., based on the image signals. More specifically, the spatial frequency would vary depending on distances between pixels concerned, or specifies a distance between pixels concerned. Further, the term of “signal intensity deviation”, defined in the present invention, represents a difference between a signal intensity of a certain pixel and another signal intensity of another pixel specified by the spatial frequency of the certain pixel.

Further, the term of “maximum signal intensity deviation”, defined in the present invention, represents a maximum value of the signal intensity deviation (signal value), which can be handled in the image-processing apparatus or system embodied in the present invention. In other words, the maximum signal intensity deviation is equivalent to a dynamic range of the signal intensity deviation (signal value) to be processed in the image-processing apparatus or system embodied in the present invention. For instance, since the values of the image signal are in a range of 0-255 in a system of 8 bits, the maximum signal intensity deviation is 255.

Still further, with respect to the description of “a pixel, whose signal intensity deviation is in a range of 0-6% of the maximum signal intensity deviation”, a pixel, whose signal intensity deviation is 0%, represents such a pixel whose signal intensity deviation is not changed.

Still further, in the present invention, a processing for multiplying the signal intensity deviation by 0 is equivalent to a processing for eliminating the signal intensity deviation.

Still further, in the present invention, the term of “to convert the image signals into luminance signals and color-difference signals” is to convert the image signals to those of YIQ base, HSV base, YUV base, etc. or to convert the image signals to those of XYZ base of CIE1931 color system, L*a*b base, L*u*v base recommended by CIE1976, based on sRGB or NTSC standard (those are well-known for a person skilled in the art). Further, the conversion method, in which the average values of R, G, B signals are established as the luminance signals, while two axes orthogonal to the luminance signals are established as the color-difference signals, would be also applicable, as set forth in, for instance, the embodiment of Tokkaisho 63-26783.

### BRIEF DESCRIPTION OF THE DRAWINGS

Other objects and advantages of the present invention will become apparent upon reading the following detailed description and upon reference to the drawings in which:

FIG. 1 shows a perspective view of the outlook structure of image-recording apparatus 1 embodied in the present invention;

FIG. 2 shows a block diagram of the internal configuration of image-recording apparatus 1;

FIG. 3 shows a block diagram of the functional configuration of image-processing section 70 embodied in the present invention;

FIG. 4 shows waveforms represented by the wavelet function;

FIG. 5 shows exemplified waveforms of input signal “S₀” and compensated high frequency band components acquired by the Dyadic Wavelet transform of every level;

FIG. 6 shows a system block diagram representing a filter processing of the Dyadic Wavelet transform of level 1 in two-dimensional signals;

FIG. 7 shows a system block diagram representing a filter processing of the Dyadic Wavelet transform of level 1 in two-dimensional signals;

FIG. 8 shows a system block diagram representing a process of applying the Dyadic Wavelet transform to input signal S₀ and acquiring output signal S₀′ to which an image processing is applied;

FIG. 9 shows a block diagram in regard to internal processing in the image adjustment processing section embodied in the present invention; and

FIG. 10 shows image evaluation results, when a plurality of image-processing operations, image-processing conditions of which are different from each other, are conducted.

### DETAILED DESCRIPTION OF THE PREFERRED EMBODIMENT

Referring to the drawings, an embodiment of the present invention will be detailed in the following.

### Outlook Configuration of Image-Recording Apparatus 1

At first, the configuration of image-recording apparatus 1 will be detailed in the following.

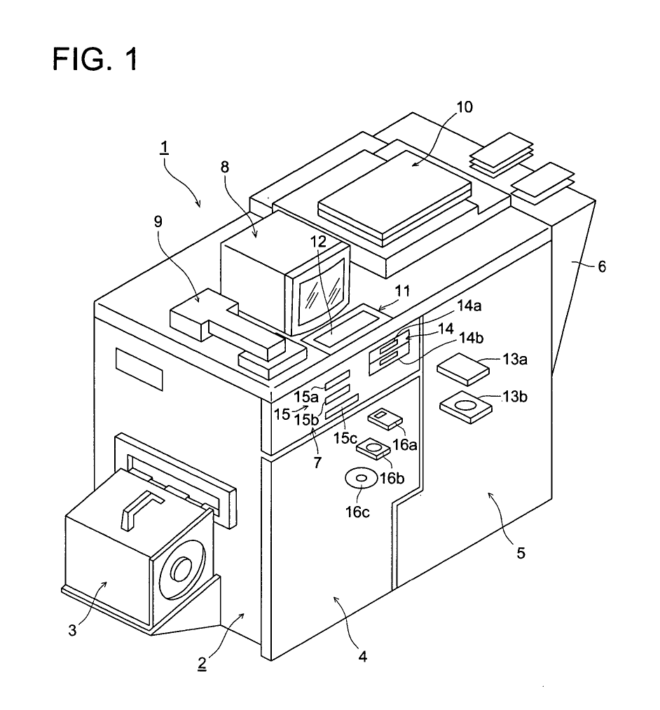

FIG. 1 shows a perspective view of the outlook structure of image-recording apparatus 1 embodied in the present invention. As shown in FIG. 1, image-recording apparatus 1 is provided with magazine loading section 3 mounted on a side of housing body 2, exposure processing section 4, for exposing a photosensitive material, mounted inside housing body 2 and print creating section 5 for creating a print. Further, tray 6 for receiving ejected prints is installed on another side of housing body 2.

Still further, CRT 8 (Cathode Ray Tube 8) serving as a display device, film scanning section 9 serving as a device for reading a transparent document, reflected document input section 10 and operating section 11 are provided on the upper side of housing body 2. CRT 8 serves as the display device for displaying the image represented by the image information to be created as the print. Further, image reading section 14 capable of reading image information recorded in various kinds of digital recording mediums and image writing section 15 capable of writing (outputting) image signals onto various kinds of digital recording mediums are provided in housing body 2. Still further, control section 7 for centrally controlling the abovementioned sections is also provided in housing body 2.

Image reading section 14 is provided with PC card adaptor 14a, floppy (Registered Trade Mark) disc adaptor 14b, into each of which PC card 13a and floppy disc 13b can be respectively inserted. For instance, PC card 13a has a storage for storing the information with respect to a plurality of frame images captured by the digital still camera. Further, for instance, a plurality of frame images captured by the digital still camera are stored in floppy disc 13b.

Image writing section 15 is provided with floppy (Registered Trade Mark) disk adaptor 15a, MO adaptor 15b and optical disk adaptor 15c, into each of which FD 16a, MO 16b and optical disc 16c can be respectively inserted. Further, CD-R, DVD-R, etc. can be cited as optical disc 16c.

Incidentally, although, in the configuration shown in FIG. 1, operating section 11, CRT 8, film scanning section 9, reflected document input section 10 and image reading section 14 are integrally provided in housing body 2, it is also applicable that one or more of them is separately disposed outside housing body 2.

Further, although image-recording apparatus 1, which creates a print by exposing/developing the photosensitive material, is exemplified in FIG. 1, the scope of the print creating method in the present invention is not limited to the above, but an apparatus employing any kind of methods, including, for instance, an ink-jetting method, an electro-photographic method, a heat-sensitive method and a sublimation method, is also applicable in the present invention.

### Internal Configuration of Image-Recording Apparatus 1

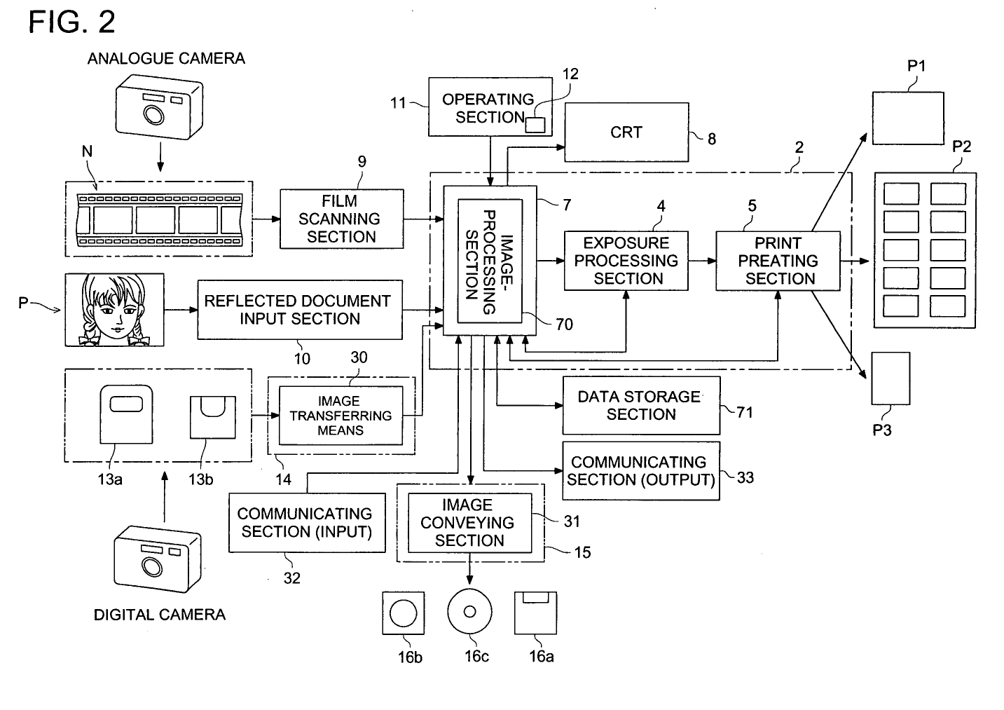

FIG. 2 shows a block diagram of the internal configuration of image-recording apparatus 1. As shown in FIG. 2, control section 7, exposure processing section 4, print creating section 5, film scanning section 9, reflected document input section 10, image reading section 14, communicating section 32 (input), image writing section 15, data storage section 71, operating section 11, CRT 8 and communicating section 33 (output) constitute image-recording apparatus 1.

Control section 7 includes a microcomputer to control the various sections constituting image-recording apparatus 1 by cooperative operations of CPU (Central Processing Unit) (not shown in the drawings) and various kinds of controlling programs, including an image-processing program, etc., stored in a storage section (not shown in the drawings), such as ROM (Read Only Memory), etc.

Further, control section 7 is provided with image-processing section 70, relating to the image-processing apparatus embodied in the present invention, which applies the image processing of the present invention to image data acquired from film scanning section 9 and reflected document input section 10, image data read from image reading section 14 and image data inputted from an external device through communicating section 32 (input), based on the input signals (command information) sent from operating section 11, to generate the image information of exposing use, which are outputted to exposure processing section 4. Further, image-processing section 70 applies the conversion processing corresponding to its output mode to the processed image data, so as to output the converted image data. Image-processing section 70 outputs the converted image data to CRT 8, image writing section 15, communicating section 33 (output), etc.

Exposure processing section 4 exposes the photosensitive material based on the image signals, and outputs the photosensitive material to print creating section 5. In print creating section 5, the exposed photosensitive material is developed and dried to create prints P1, P2, P3. Incidentally, prints P1 include service size prints, high-vision size prints, panorama size prints, etc., prints P2 include A4-size prints, and prints P3 include visiting card size prints.

Film scanning section 9 reads the frame image data from developed negative film N acquired by developing the negative film having an image captured by an analogue camera so as to acquire digital image signals of the frame image. Reflected document input section 10 reads an image recorded on prints P (such as photographic prints, paintings and calligraphic works, various kinds of printing materials, etc.) by means of a flat bed scanner installed in it, so as to acquire digital image signals of the image.

Image reading section 14 reads the frame image information stored in PC card 13a and floppy (Registered Trade Mark) disc 13b to transfer the acquired image information to control section 7. Further, image reading section 14 is provided with PC card adaptor 14a, floppy disc adaptor 14b serving as an image transferring means 30. Still further, image reading section 14 reads the frame image information stored in PC card 13a inserted into PC card adaptor 14a and floppy disc 13b inserted into floppy disc adaptor 14b to transfer the acquired image information to control section 7. For instance, the PC card reader or the PC card slot, etc. can be employed as PC card adaptor 14a.

Communicating section 32 (input) receives image signals representing the captured image and print command signals sent from a separate computer located within the site in which image-recording apparatus 1 is installed and/or from a computer located in a remote site through Internet, etc.

Image writing section 15 is provided with floppy disk adaptor 15a, MO adaptor 15b and optical disk adaptor 15c, serving as image conveying section 31. Further, according to the writing signals inputted from control section 7, image writing section 15 writes the data, generated by the image-processing method embodied in the present invention, into floppy disk 16a inserted into floppy disk adaptor 15a, MO disc 16b inserted into MO adaptor 15b and optical disk 16c inserted into optical disk adaptor 15c.

Data storage section 71 stores the image information and its corresponding order information (including information of a number of prints and a frame to be printed, information of print size, etc.) to sequentially accumulate them in it.

Operating section 11 is provided with information inputting means 12. Information inputting means 12 is constituted by a touch panel, etc., so as to output a push-down signal generated in information inputting means 12 to control section 7 as an inputting signal. Incidentally, it is also applicable that operating section 11 is provided with a keyboard, a mouse, etc. Further, CRT 8 displays image information, etc., according to the display controlling signals inputted from control section 7.

Communicating section 33 (output) transmits the output image signals, representing the captured image and processed by the image-processing method embodied in the present invention, and its corresponding order information to a separate computer located within the site in which image-recording apparatus 1 is installed and/or to a computer located in a remote site through Internet, etc.

### Configuration of Image-Processing Section 70

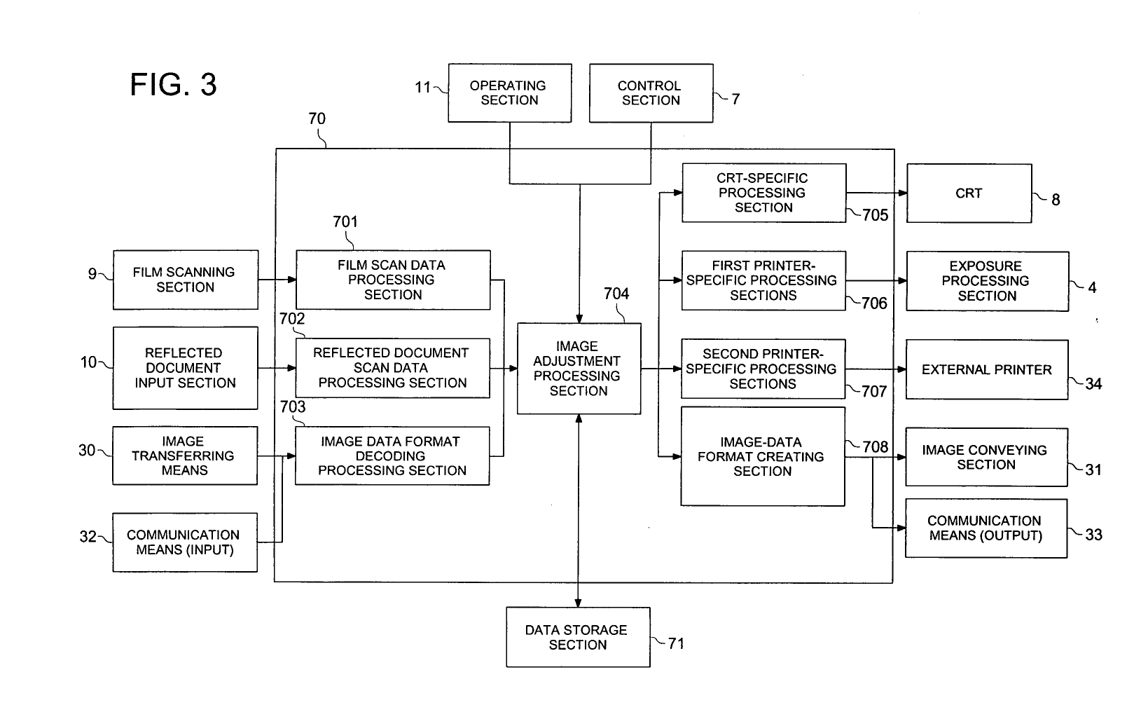

FIG. 3 shows a block diagram of the functional configuration of image-processing section 70 embodied in the present invention. As shown in FIG. 3, film scan data processing section 701, reflected document scan data processing section 702, image data format decoding processing section 703, image adjustment processing section 704, CRT-specific processing section 705, first printer-specific processing sections 706, second printer-specific processing sections 707 and image-data format creating section 708 constitute image-processing section 70.

In film scan data processing section 701, various kinds of processing, such as calibrating operations inherent to film scanning section 9, a negative-to-positive inversion in case of negative document, a gray balance adjustment, a contrast adjustment, etc., are applied to the image signals inputted from film scanning section 9, and then, processed image signals are transmitted to image adjustment processing section 704. Further, film scan data processing section 701 also transmits a film size and a type of negative/positive, as well as an ISO sensitivity, a manufacturer's name, information on the main subject and information on photographic conditions (for example, information described in APS), optically or magnetically recorded on the film, to the image adjustment processing section 704.

In reflected document scan data processing section 702, the calibrating operations inherent to reflected document input section 10, the negative-to-positive inversion in case of negative document, the gray balance adjustment, the contrast adjustment, etc., are applied to the image signals inputted from reflected document input section 10 and then, processed image signals are transmitted to image adjustment processing section 704.

Image data format decoding processing section 703 performs converting operations of the method for reproducing the compressed code or the method for representing color signals, etc., according to the data format of the image data inputted from image transferring means 30 or communicating section 32 (input), and then, transmits converted image signals to image adjustment processing section 704.

Image adjustment processing section 704 can receive the image information processed and outputted by each of film scan data processing section 701, reflected document scan data processing section 702 and image data format decoding processing section 703, and further, can also receive the information pertaining to the main subject and the information on the photographic conditions, generated by inputting operations at operating section 11.

Image adjustment processing section 704 decomposes the color image signals inputted from anyone of film scan data processing section 701, reflected document scan data processing section 702 and image data format decoding processing section 703 into the luminance signals and the color-difference signals. Then a processing for increasing the signal intensity deviation (namely, a sharpness-enhancement processing) is applied to an objective pixel, which is included in objective pixels having a spatial frequency in a range of 1.5-3.0 lines/mm, and whose signal intensity deviation is in a range of 30-60% of a maximum signal intensity deviation, while another processing for decreasing the signal intensity deviation is applied to another objective pixel, which is included in objective pixels having a spatial frequency in a range of 0.7-3.0 lines/mm, and whose signal intensity deviation is in a range of 0-6% of the maximum signal intensity deviation. The other processing for decreasing the signal intensity deviation (namely, a noise reduction processing) corresponds to a processing for eliminating the noise components included in image signals of the high frequency band component. Incidentally, it is also applicable that the noise reduction processing is not applied to the other objective pixel, which is included in objective pixels having a spatial frequency in a range of 0.7-3.0 lines/mm, and whose signal intensity deviation is in a range of 0-6% of the maximum signal intensity deviation.

As a method for measuring changing rates of variable amounts of the spatial frequency and the signal intensity, the following steps would be applicable:

(1) inserting a plurality of sinusoidal image signals, whose spatial frequencies and amplitudes are different from each other, into image signals prior to the processing, by employing a retouch software sold in a market, etc., and then, applying an image-processing to the above-processed image signals; and

(2) measuring a change amount between the amplitude of the image signal prior to the processing and that of the processed image signal.

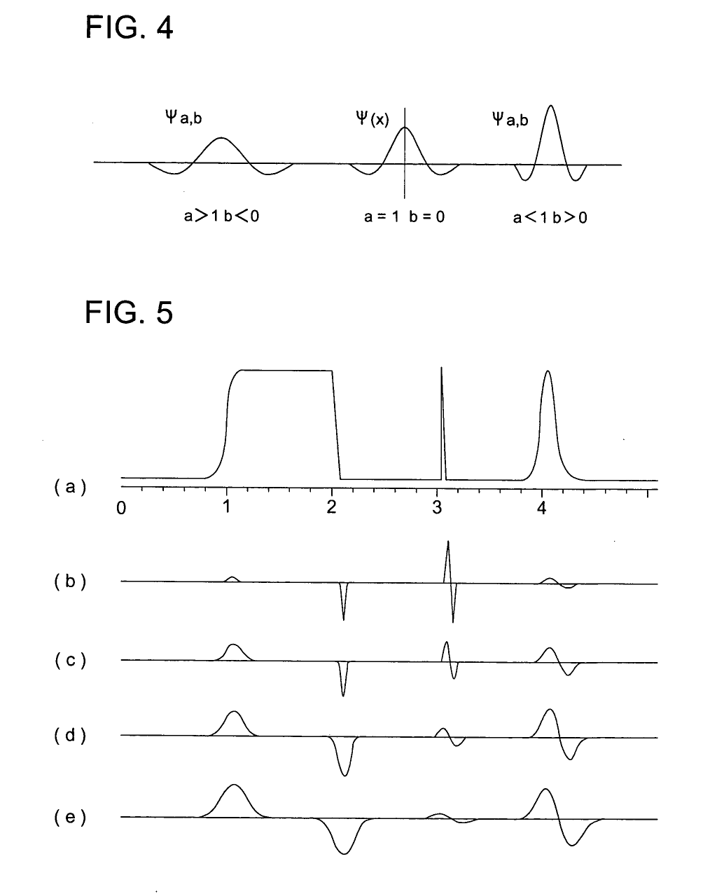

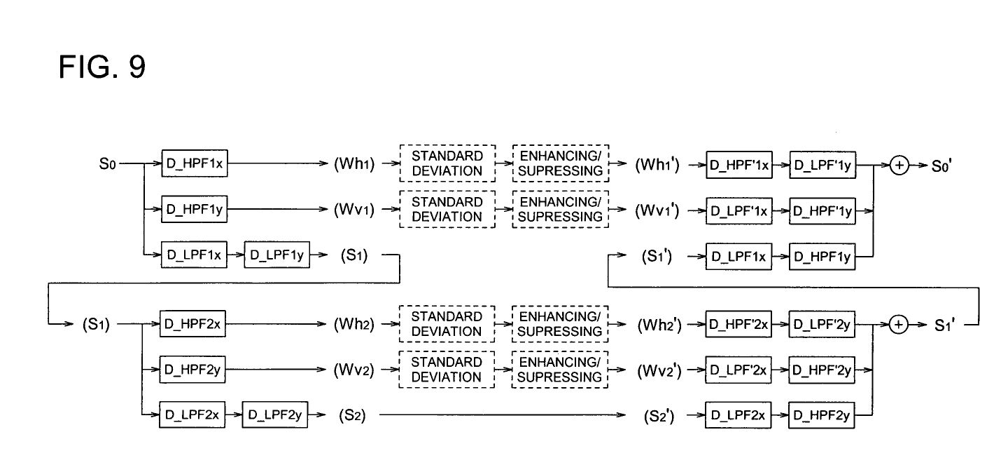

As a concrete example of the sharpness-enhancement processing and the noise reduction processing mentioned in the above, the Dyadic Wavelet transform, being one of various wavelet transforms, can be employed. Further, when applying the sharpness-enhancement processing, it is possible to employ a combination of the sharpness-enhancement processing technique of general purpose and the Dyadic Wavelet transform. The summary of the wavelet transform and the Dyadic Wavelet transform will be detailed later on, referring to FIG. 4-FIG. 8. Further, the sharpness-enhancement processing and the noise reduction processing, which employs the Dyadic Wavelet transform, will be detailed later on, referring to FIG. 9.

Further, based on the command signals outputted from operating section 11 or control section 7, image adjustment processing section 704 outputs the processed image signals to CRT-specific processing section 705, first printer-specific processing sections 706, second printer-specific processing sections 707, image-data format creating section 708 and data storage section 71.

CRT-specific processing section 705 applies a pixel number changing processing, a color matching processing, etc. to the processed image signals received from image adjustment processing section 704, as needed, and then, transmits display signals synthesized with information necessary for displaying, such as control information, etc., to CRT 8.

First printer-specific processing sections 706 applies a calibrating processing inherent to exposure processing section 4, a color matching processing, a pixel number changing processing, etc. to the processed image signals received from image adjustment processing section 704, as needed, and then, transmits output image signals to exposure processing section 4.

In case that external printing apparatus 34, such as a large-sized printing apparatus, etc., is coupled to image-recording apparatus 1 embodied in the present invention, a printer-specific processing section, such as second printer-specific processing sections 707, is provided for every apparatus, so as to conduct an appropriate calibrating processing for each specific printer, a color matching processing, a pixel number change processing, etc.

In image-data format creating section 708, the format of the image signals received from image adjustment processing section 704 are converted to one of various kinds of general-purpose image formats, represented by JPEG (Joint Photographic Coding Experts Group), TIFF (Tagged Image File Format), Exif (Exchangeable Image File Format), etc., as needed, and then, the converted image signals are transmitted to image conveying section 31 or communicating section (output) 33.

Incidentally, the aforementioned sections, such as film scan data processing section 701, reflected document scan data processing section 702, image data format decoding processing section 703, image adjustment processing section 704, CRT-specific processing section 705, first printer-specific processing sections 706, second printer-specific processing sections 707 and image-data format creating section 708, are eventually established for helping the understandings of the functions of image-processing section 70 embodied in the present invention. Accordingly, it is needless to say that each of these sections is not necessary established as a physically independent device, but is possibly established as a kind of software processing section with respect to a single CPU (Central Processing Unit). Further, the scope of the image-recording apparatus 1 embodied in the present invention is not limited to the above, but it is also applicable for various kinds of embodiments including a digital photo-printer, a printer driver, plug-ins of various kinds of image-processing software, etc.

### Summary of Wavelet Transform

The wavelet transform is one of the multi-resolution conversion processing. In this method, one converting operation allows the inputted signals to be decomposed into high-frequency component signals and low-frequency component signals, and then, a same kind of converting operation is further applied to the acquired low-frequency component signals, in order to obtain the multiple resolution signals including a plurality of signals locating in frequency bands being different relative to each other. The multiple resolution signals can be restructured to the original signals by applying the multiple resolution inverse-conversion to the multiple resolution signals as it is without adding any modification to them. The detailed explanations of such the methods are set forth in, for instance, “Wavelet and Filter banks” by G. Strang & T. Nguyen, Wellesley-Cambridge Press.

The wavelet transform is operated as follows: In the first place, the following wavelet function shown in equation (1), where vibration is observed in a finite range as shown in FIG. 4, is used to obtain the wavelet transform coefficient <f, ψ_{a, b}> with respect to input signal f(x) by employing equation (2). Through this process, input signal is converted into the sum total of the wavelet function shown in equation (3).

$$\begin{matrix}{ψ}_{a , b} ( x ) = ψ ( \frac{x - b}{a} ) & ( 1 ) \\ ⟨ f , {ψ}_{a , b} ⟩ ≡ \frac{1}{a} \int f ( x ) \cdot ψ ( \frac{x - b}{a} ) ⅆ x & ( 2 ) \\ f ( x ) = {\sum }_{a , b}^{} ⟨ f , {ψ}_{a , b} ⟩ \cdot {ψ}_{a , b} ( x ) & ( 3 )\end{matrix}$$

In the above equations (1)-(3), “a” denotes the scale of the wavelet function, and “b” the position of the wavelet function. As shown in FIG. 4, as the value “a” is greater, the frequency of the wavelet function ψ_{a, b}(x) is smaller. The position where the wavelet function ψ_{a, b}(x) vibrates moves according to the value of position “b”. Thus, equation (3) signifies that the input signal f(x) is decomposed into the sum total of the wavelet function ψ_{a, b}(x) having various scales and positions.

### Dyadic Wavelet Transform

Next, the Dyadic Wavelet transform, being one of the wavelet transforms, will be detailed in the following. The detailed explanations for the Dyadic Wavelet transform employed in the present invention are set forth in the non-Patent Documents, such as “Singularity detection and processing with wavelets” by S. Mallat and W. L. Hwang, IEEE Trans. Inform. Theory 38 617 (1992), “Characterization of signal from multiscale edges” by S. Mallet and S. Zhong, IEEE Trans. Pattern Anal. Machine Intel. 14 710 (1992), and “A wavelet tour of signal processing 2ed.” by S. Mallat, Academic Press.

The wavelet function employed in the Dyadic Wavelet transform is defined by equation (4) shown below.

$${ψ}_{i , j} ( x ) = {2}^{- i} ψ ( \frac{x - j}{{2}^{i}} ) \qquad ( 4 )$$

where “i” denotes a natural number. As shown in FIG. (4), in the orthogonal wavelet transform, the value of scale “a” is defined discretely by an i-th power of “2”. This value “i” is called a level.

Employing the wavelet function ψ_{1, j}(x) shown in equation (4), the input signal f(x) can be expressed by the following equation (5).

$$\begin{matrix}f ( x ) ≡ {S}_{0} \\ = {\sum }_{j}^{} ⟨ {S}_{0} , {ψ}_{1 , j} ⟩ \cdot {ψ}_{1 , j} ( x ) + {\sum }_{j}^{} ⟨ {S}_{0} , {φ}_{1 , j} ⟩ \cdot {φ}_{1 , j} ( x ) \\ ≡ {\sum }_{j}^{} {W}_{1} ( j ) \cdot {ψ}_{1 , j} ( x ) + {\sum }_{j}^{} {S}_{1} ( j ) \cdot {ψ}_{1 , j} ( x )\end{matrix} \qquad ( 5 )$$

Incidentally, the second term of equation (5) denotes that the low frequency band component of the residue that cannot be represented by the sum total of wavelet function ψ_{1, j}(x) of level 1 is represented in terms of the sum total of scaling function φ_{1, j}(x). An adequate scaling function in response to the wavelet function is employed (refer to the aforementioned reference). This means that input signal f(x)≡S₀ is decomposed into the high frequency band component W₁ and low frequency band component Sᵢ of level 1 by the wavelet transform of level 1 shown in equation (5).

As shown in the following equation (6), low frequency band component Sᵢ₋₁ of level i−1 can be decomposed into the high frequency band component Wᵢ and low frequency band component Sᵢ of level “i”.

$$\begin{matrix}{S}_{i - 1} = {\sum }_{j}^{} ⟨ {S}_{i - 1} , {ψ}_{1 , j} ⟩ \cdot {ψ}_{1 , j} ( x ) + {\sum }_{j}^{} ⟨ {S}_{i - 1} , {φ}_{i , j} ⟩ \cdot {φ}_{i , j} ( x ) \\ ≡ {\sum }_{j}^{} {W}_{i} ( j ) \cdot {ψ}_{i , j} ( x ) + {\sum }_{j}^{} {S}_{i} ( j ) \cdot {φ}_{i , j} ( x )\end{matrix} \qquad ( 6 )$$

As shown in equation (4), since the minimum traveling unit of the position “b” is kept constant in the wavelet function of the Dyadic Wavelet transform, regardless of level “i”, the Dyadic Wavelet transform has the following characteristics.

Characteristic 1: The signal volume of each of high frequency band component Wᵢ and low frequency band component Sᵢ generated by the Dyadic Wavelet transform of level 1 shown by equation (6) is the same as that of signal Sᵢ₋₁ prior to transform.

Characteristic 2: The scaling function φ_{i, j}(x) and the wavelet function ψ_{i, j}(x) fulfill the following relationship shown by equation (7).

$${ψ}_{i , j} ( x ) = \frac{\partial }{\partial x} {φ}_{i , j} ( x ) \qquad ( 7 )$$

Thus, the high frequency band component Wᵢ generated by the Dyadic Wavelet transform of level 1 represents the first differential (gradient) of the low frequency band component Sᵢ.

Characteristic 3: With respect to Wᵢ·γᵢ (hereinafter referred to as “compensated high frequency band component) obtained by multiplying the coefficient γᵢ (refer to the aforementioned reference documents in regard to the Dyadic Wavelet transform) determined in response to the level “i” of the Wavelet transform, by high frequency band component, the relationship between levels of the signal intensities of compensated high frequency band components Wᵢ·γᵢ subsequent to the above-mentioned transform obeys a certain rule, in response to the singularity of the changes of input signals, as described in the following.

FIG. 5 shows exemplified waveforms of input signal “S₀” and compensated high frequency band components acquired by the Dyadic Wavelet transform of every level.

Namely, FIG. 5 shows exemplified waveforms of: input signal “S₀” at line (a); compensated high frequency band component W₁·γ₁, acquired by the Dyadic Wavelet transform of level 1, at line (b); compensated high frequency band component W₂·γ₂, acquired by the Dyadic Wavelet transform of level 2, at line (c); compensated high frequency band component W₃·γ₃, acquired by the Dyadic Wavelet transform of level 3, at line (d); and compensated high frequency band component W₄·₄, acquired by the Dyadic Wavelet transform of level 4, at line (e).

Observing the changes of the signal intensities step by step, the signal intensity of the compensated high frequency band component Wᵢ·γᵢ, corresponding to a gradual change of the signal intensity shown at “1” and “4” of line (a), increases according as the level number “i” increases, as shown in line (b) through line (e).

With respect to input signal “S₀”, the signal intensity of the compensated high frequency band component Wᵢ·γᵢ, corresponding to a stepwise signal change shown at “2” of line (a), is kept constant irrespective of the level number “i”. Further, with respect to input signal “S₀”, the signal intensity of the compensated high frequency band component Wᵢ·γᵢ, corresponding to a signal change of δ-function shown at “3” of line (a), decreases according as the level number “i” increases, as shown in line (b) through line (e).

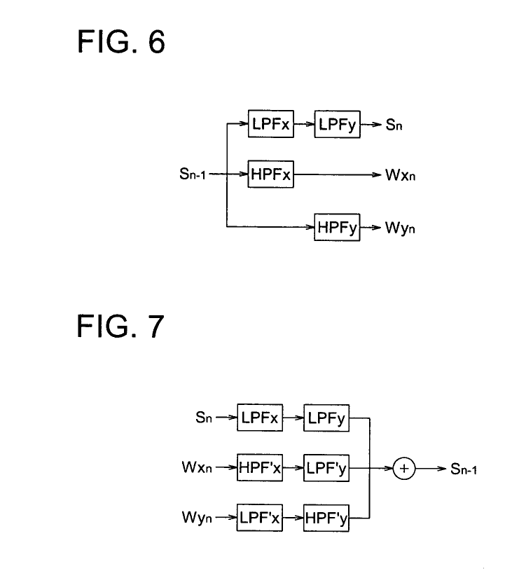

Characteristic 4: The method of Dyadic Wavelet transform of level 1 in respect to the two-dimensional signals such as the image signals is followed as shown in FIG. 6.

As shown in FIG. 6, in the Dyadic Wavelet transform of level 1, low frequency band component Sₙ can be acquired by processing input signal Sₙ₋₁ with low-pass filter LPFₓ in the direction of. “x” and low-pass filter LPF_{y} in the direction of “y”. Further, a high frequency band component Wxₙ can be acquired by processing input signal Sₙ₋₁ with high-pass filter HPFₓ in the direction of “x”, while another high frequency band component Wyₙ can be acquired by processing input signal Sₙ₋₁ with high-pass filter HPF_{y} in the direction of “y”.

The low frequency band component Sₙ₋₁ is decomposed into two high frequency band components Wxₙ, Wyₙ and one low frequency band component Sₙ by the Dyadic Wavelet transform of level 1. Two high frequency band components correspond to components x and y of the change vector Vₙ in the two dimensions of the low frequency band component Sₙ. The magnitude Mₙ of the change vector Vₙ and angle of deflection Aₙ are given by equation (8) and equation (9) shown as follow.

Mₙ=\sqrt{Wxₙ²+Wyₙ²} (8)

Aₙ=argument(Wxₙ+iWyₙ) (9)

Sₙ₋₁ prior to transform can be reconfigured when the Dyadic Wavelet inverse transform shown in FIG. 7 is applied to two high frequency band components Wxₙ, Wyₙ and one low frequency band component Sₙ. In other words, input signal Sₙ₋₁ prior to transform can be reconstructed by adding the signals of: the signal acquired by processing low frequency band component Sₙ with low-pass filters LPFₓ and LPF_{y}, both used for the forward transform in the directions of “x” and “y”; the signal acquired by processing high frequency band component Wxₙ with high-pass filter HPF′ₓ in the direction of “x” and low-pass filter LPF′_{y} in the direction of “y”; and the signal acquired by processing high frequency band component Wyₙ with low-pass filter LPF′ₓ in the direction of “x” and high-pass filter HPF′_{y} in the direction of “y”; together.

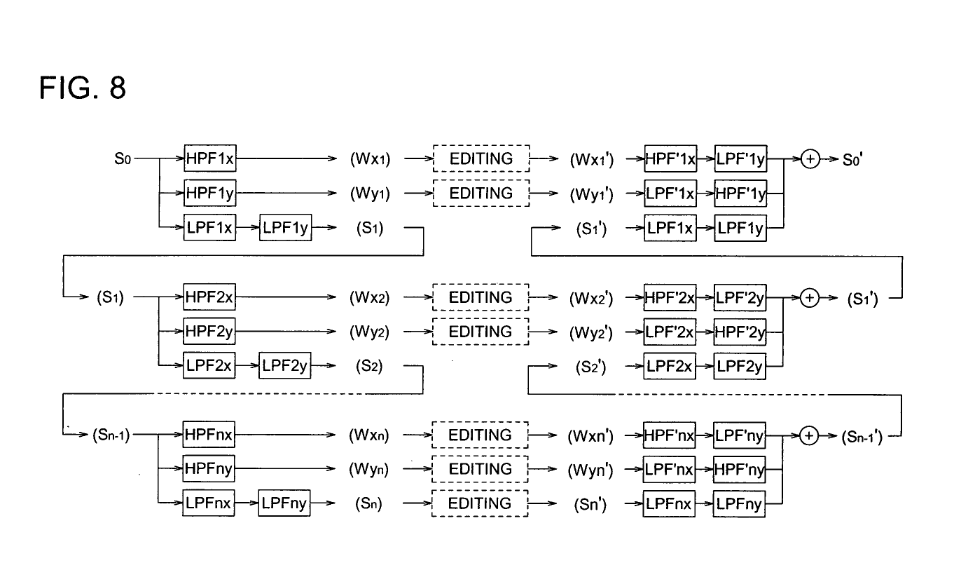

Next, referring to the block diagram shown in FIG. 8, the method for acquiring output signals S₀′, having the steps of applying the Dyadic Wavelet transform of level “n” to input signals “S₀”, applying a certain kind of image-processing (referred to as “editing” in FIG. 8) to the acquired high frequency band components and the acquired low frequency band component, and then, conducting the Dyadic Wavelet inverse-transform to acquire output signals S₀′, will be detailed in the following.

In the Dyadic Wavelet transform of level 1 for input signal “S₀”, input signal “S₀” is decomposed into two high frequency band components Wx₁, Wy₁ and low frequency band component S₁. In the Dyadic Wavelet transform of level 2, low frequency band component S₁ is further decomposed into two high frequency band components Wx₂, Wy₂ and low frequency band component S₂. By repeating the abovementioned operational processing up to level “n”, input signal “S₀” is decomposed into a plurality of high frequency band components Wx₁, Wx₂, - - - WXₙ, Wy₁, Wy₂, - - - Wyₙ and a single low frequency band component Sₙ.

The image-processing (the editing operations) are applied to high frequency band components Wx₁, Wx₂, - - - Wxₙ, Wy₁, Wy₂, - - - Wyₙ and low frequency band component Sₙ generated through the abovementioned processes to acquire edited high frequency band components Wx₁′, Wx₂′, - - - Wxₙ′, Wy₁′, Wy₂′, - - - Wyₙ′ and edited low frequency band component Sₙ′.

Then, the Dyadic Wavelet inverse-transform is applied to edited high frequency band components Wx₁′, Wx₂′, - - - Wxₙ′, Wy₁′, Wy₂′, - - - Wyₙ′ and edited low frequency band component Sₙ′. Specifically speaking, the edited low frequency band component Sₙ₋₁′ of level (n−1) is restructured from the two edited high frequency band components Wxₙ′, Wyₙ′ of level “n” and the edited low frequency band component Sₙ′ of level N. By repeating this operation shown in FIG. 9, the edited low frequency band component S₁′ of level 1 is restructured from the two edited high frequency band components Wx₂′, Wy₂′ of level 2 and the edited low frequency band component S₂′ of level 2. Successively, the edited low frequency band component S₀′ is restructured from the two edited high frequency band components Wx₁′, Wy₁′ of level 1 and the edited low frequency band component S₁′ of level 1.

The filter coefficients of the filters, employed for the operations shown in FIG. 8, are appropriately determined corresponding to the wavelet functions. Further, in the Dyadic Wavelet transform, the filter coefficients, employed for every level number, are different relative to each other. The filtering coefficients employed for level “n” are created by inserting 2ⁿ⁻¹−1 zeros into each interval between filtering coefficients for level 1. The abovementioned procedure is set forth in the aforementioned reference document.

### Sharpness-Enhancement Processing and Noise-Reduction Processing

Next, as an example of the processing conducted in image adjustment processing section 704 shown in FIG. 3, a sharpness-enhancement processing and a noise-reduction processing, in which the Dyadic Wavelet transform is employed, will be detailed in the following. FIG. 9 shows a system block diagram with respect to the processing in which the Dyadic Wavelet transform (and the Dyadic Wavelet inverse-transform) is employed.

Further, the filters having the following coefficients shown in Table 1 are employed in the Dyadic Wavelet transform and its inverse-transform. In Table 1 and FIG. 9, D_HPF1 and D_LPF1 denote the high-pass filter and the low-pass filter used for the Dyadic Wavelet transform, respectively. Further, D_HPF′1 and D_LPF′1 denote the high-pass filter and the low-pass filter used for the Dyadic Wavelet inverse-transform, respectively.

TABLE 1

| α | D_HPF1 | D_LPF1 | D_HPF′ 1 | D_LPF′ 1 |
|---|---|---|---|---|
| −3 | | | 0.0078125 | 0.0078125 |
| −2 | | | 0.054585 | 0.046875 |
| −1 | | 0.125 | 0.171875 | 0.1171875 |
| 0 | 2.0 | 0.375 | −0.171875 | 0.65625 |
| 1 | 2.0 | 0.375 | −0.054685 | 0.1171875 |
| 2 | | 0.125 | −0.0078125 | 0.046875 |
| 3 | | | | 0.0078125 |

In Table 1, the coefficients for α=0 corresponds to a current pixel currently being processed, the coefficients for α=−1 corresponds to a pixel just before the current pixel, the coefficients for α=+1 corresponds to a pixel just after the current pixel.

Further, in the Dyadic Wavelet transform, the filter coefficients are different relative to each other for every level. A coefficient obtained by inserting 2ⁿ⁻¹−1 zeros between coefficients of filters on level 1 is used as a filter coefficient on level “n”.

Each of the compensation coefficients γᵢ determined in response to the level “i” of the Dyadic Wavelet transform is shown in Table 2.

TABLE 2

| i | γ |
|---|---|
| 1 | 0.66666667 |
| 2 | 0.89285714 |
| 3 | 0.97087379 |
| 4 | 0.99009901 |
| 5 | 1 |

Next, referring to FIG. 9, operations in the embodiment of the present invention will be detailed in the following.

Initaly, color image signals, inputted from anyone of film scan data processing section 701, reflected document scan data processing section 702 and image data format decoding processing section 703, are converted from RGB signals to a luminance signal and a color-difference signal. Then, the Dyadic Wavelet transform up to level A is applied to the luminance signal. Further, standard deviation σ of absolute values of image signal intensities of the high frequency band components generated by applying the Dyadic Wavelet transform of level “i” is calculated, in order to determine threshold value σ*Bi, serving as a reference for the sharpness enhancement, and threshold value σ*Ci, serving as a reference for the noise reduction, where “*” denotes a multiplying operator.

As a next step, among the image signals of high frequency band components generated by applying the Dyadic Wavelet transform of level “i”, a signal intensity of a pixel, whose signal intensity is equal to or more than threshold value σ*Bi, is enhanced by Di times (Di>1.0), while a signal intensity of a pixel, whose signal intensity is equal to or less than threshold value σ*Ci, is suppressed by Ei times (Ei≦1.0). After the abovementioned sharpness enhancement processing and the noise reduction processing are completed, the Dyadic Wavelet inverse-transform is applied. Incidentally, when signal intensities of pixels whose intensity deviations reside in a range of 0-6% of maximum signal deviation, with a spatial frequency range of 0.7-3.0 lines/mm, are not intended to change, namely, signal intensity deviations are set at 1.0 time, multiple Ei is set at 1.0.

Each of level A, coefficient Bi, coefficient Ci, multiple Di and multiple Ei varies depending on a kind of subject in the image, a number of pixels included in the image signals, an output resolution, an output image size, etc. For instance, in case that an image, recorded on a silver-halide film of ISO800 and 135 size, is read by the film scanner with a reading resolution of 40-80 pixels/mm, and printed out onto a silver-halide film of 2L size with a outputting resolution of 300 dpi after applying the image-processing, the abovementioned values are set at A=2, B1=0.6, C1=0, D1=1.3, E1=0, B2=0.8, C2=0.7, D2=1.6 and E2=0. Referring to FIG. 9, the processing in the abovementioned case will be detailed in the following.

Establishing input signal S₀ as luminance signal S₀, the Dyadic Wavelet transform of level 1 is applied to luminance signal S₀ so as to generate high frequency band components Wv₁, Wh₁ and low frequency band component S₁. After that, the Dyadic Wavelet transform of level 2 is further applied to low frequency band component S₁ so as to generate high frequency band components Wv₂, Wh₂ and low frequency band component S₂.

In the next step, standard deviation 6 of the absolute value of image signal intensity of each of the high frequency band components generated by applying the Dyadic Wavelet transform of level 1 and level 2 is calculated, in order to determine threshold value σ*0.6 serving as the reference for the sharpness enhancement at level 1, threshold value σ*0.4 serving as the reference for the noise reduction at level 1, threshold value σ*0.8 serving as the reference for the sharpness enhancement at level 2 and threshold value σ*0.7 serving as the reference for the noise reduction at level 2.

Further, the processing for enhancing the signal intensities of the pixels, whose signal intensities are equal to or more than σ*0.6, by 1.3 times, while for suppressing the signal intensities of the pixels, whose signal intensities are equal to or less than σ*0.4, to zero, is applied to each of high frequency band components Wv₁, Wh₁ derived by the Dyadic Wavelet transform of level 1. In addition, the processing for enhancing the signal intensities of the pixels, whose signal intensities are equal to or more than σ*0.8, by 1.6 times, while for suppressing the signal intensities of the pixels, whose signal intensities are equal to or less than σ*0.7, to zero, is applied to each of high frequency band components Wv₂, Wh₂ derived by the Dyadic Wavelet transform of level 2.

After applying the enhancement and suppression processing, the Dyadic Wavelet inverse-transform is conducted so as to acquire processed luminance signal S₀′. Then, processed luminance signal S₀′ is converted to RGB signals (not shown in the drawings), which are outputted as processed color image signals.

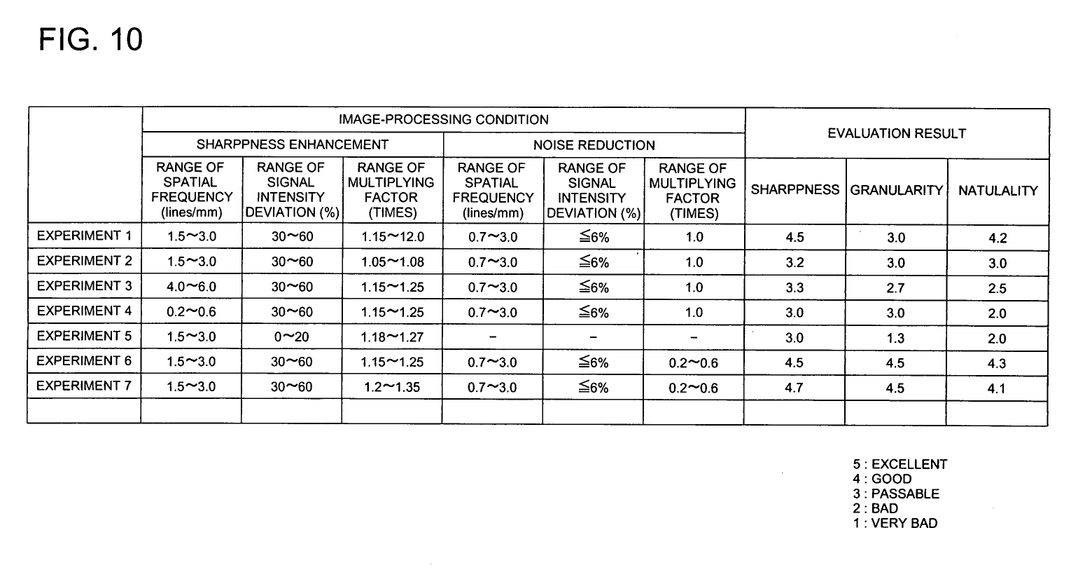

FIG. 10 shows an image evaluation result, when plural image-processing, embodied in the present invention, are conducted. Concretely speaking, FIG. 10 shows the image evaluation result in case that an image, recorded on a silver-halide film of IS0800 and 135 size, is read by the film scanner with a reading resolution of 40-80 pixels/mm, and printed out onto a silver-halide film of 2L size with a outputting resolution of 300 dpi after applying the image-processing embodied in the present invention. Further, the image evaluation results shown in FIG. 10 are the average values of 5 step evaluations performed by 10 subjects, when 7 image processing, which correspond to experiment 1-experiment 7 and image-processing conditions of which are different relative to each other, are conducted. Incidentally, the image-processing conditions defined hereinafter includes a spatial frequency range of image signals, a signal intensity deviating range for the maximum signal intensity deviation, a range (distribution) of multiple numbers for multiplying the signal intensity deviation for the sharpness-enhancement processing or the noise-reduction processing.

According to FIG. 10, it can be found that the evaluation results in case of conducting the image-processing categorized in experiment 1, experiment 6 and experiment 7 are higher than those in case of conducting the image-processing categorized in other experiments. Accordingly, it would be appropriate that, with respect to a pixel, whose spatial frequency is in a range of 1.5-3.0 lines/mm and whose signal intensity deviation is in a range of 30-60% of the maximum signal deviation, a processing (namely, the sharpness-enhancement processing) for multiplying the signal intensity deviation of the pixel by a factor in a range of 1.1-1.5 (especially, in a range of 1.15-1.35) is applied, while, with respect to a pixel, whose spatial frequency is in a range of 0.7-3.0 lines/mm and whose signal intensity deviation is in a range of 0-6% of the maximum signal deviation, a processing (namely, the noise-reduction processing) for multiplying the signal intensity deviation of the pixel by a factor in a range of 0-0.75 (especially, in a range of 0.2-0.6) or for reducing it to zero (namely, the noise-reduction processing) is applied.

Incidentally, with respect to a pixel, whose spatial frequency is in a range of 1.5-3.0 lines/mm and whose signal intensity deviation is in a range of 30-60% of the maximum signal deviation, although it is possible to acquire a good sharpness property by multiplying the signal intensity deviation of the pixel by a factor of more than 1.5, sometimes, artifacts would occur in the image depending on a kind of subject image. Therefore, it is desirable that the multiplying factor is set at equal to or smaller than 1.5 as mentioned in the above.

Further, it is also applicable to increase the signal intensity deviation of a pixel, whose spatial frequency is in a range of 1.5-3.0 lines/mm and whose current signal intensity deviation is outside the range of 30-60% of the maximum signal deviation, at an increasing rate lower than that for a pixel located inside the range. For instance, when multiplying the signal intensity deviation of the pixel, whose spatial frequency is in a range of 1.5-3.0 lines/mm and whose current signal intensity deviation is in the range of 30-60% of the maximum signal deviation, by a factor in a range of 1.1-1.5, it is applicable to multiply the signal intensity deviation of a pixel, whose spatial frequency is in a range of 3.0-3.5 lines/mm and whose current signal intensity deviation is in the range of 30-60% of the maximum signal deviation, by a factor of 1.05.

Still further, it is also applicable to decrease the signal intensity deviation of a pixel, whose spatial frequency is in a range of 0.7-3.0 lines/mm and whose current signal intensity deviation is outside the range of 0-6% of the maximum signal deviation, at an decreasing rate lower than that for a pixel located inside the range. For instance, it is applicable to multiply the signal intensity deviation of a pixel, whose spatial frequency is in a range of 1.5-3.0 lines/mm and whose current signal intensity deviation is in the range of 0-3% of the maximum signal deviation, by a factor in a range of 0-0.5.

As described in the foregoing, according to image-recording apparatus 1 embodied in the present invention, by applying the processing (namely, the sharpness-enhancement processing) for increasing the signal intensity deviation of the pixel, whose spatial frequency is in a range of 1.5-3.0 lines/mm and whose signal intensity deviation is in a range of 30-60% of the maximum signal deviation, and by applying the processing (namely, the noise-reduction processing) for decreasing the signal intensity deviation of the pixel, whose spatial frequency is in a range of 0.7-3.0 lines/mm and whose signal intensity is in a range of 0-6% of the maximum signal deviation, or keeping it as it is, it becomes possible to suppress the granularity of the image, resulting in an improvement or the sharpness property of the image.

Disclosed embodiment can be varied by a skilled person without departing from the spirit and scope of the invention.

What is claimed is:

1. An image-processing method for applying a predetermined image processing to image signals, representing a plurality of pixels included in an image, so as to output processed image signals, comprising the steps of:
applying a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and
applying a second processing for decreasing said signal intensity deviation or keeping said signal intensity deviation as it is to a second-objective pixel, which is included in objective pixels having a spatial frequency in a range of 0.7-3.0 lines/mm, and whose signal intensity deviation is in a range of 0-6% of said maximum signal intensity deviation.

2. The image-processing method of claim 1,
wherein said first processing includes a sharpness-enhancement processing, while said second processing includes a noise-reduction processing.

3. The image-processing method of claim 1,
wherein said first processing multiplies said signal intensity deviation of said first-objective pixel by a factor in a range of 1.1-1.5.

4. The image-processing method of claim 1,
wherein said second processing multiplies said signal intensity deviation of said second-objective pixel by a factor in a range of 0-0.75.

5. The image-processing method of claim 1, further comprising the step of:
converting objective image signals, representing said objective pixels, to luminance signals and color-difference signals;
wherein said first processing is applied to said luminance signals in said step of applying said first processing, while said second processing is applied to said color-difference signals in said step of applying said second processing.

6. An image-processing apparatus for applying a predetermined image processing to image signals, representing a plurality of pixels included in an image, so as to output processed image signals, comprising:
a first processing section to apply a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and
a second processing section to apply a second processing for decreasing said signal intensity deviation or keeping said signal intensity deviation as it is to a second-objective pixel, which is included in objective pixels having a spatial frequency in a range of 0.7-3.0 lines/mm, and whose signal intensity deviation is in a range of 0-6% of said maximum signal intensity deviation.

7. The image-processing apparatus of claim 6,
wherein said first processing includes a sharpness-enhancement processing, while said second processing includes a noise-reduction processing.

8. The image-processing apparatus of claim 6,
wherein said first processing section multiplies said signal intensity deviation of said first-objective pixel by a factor in a range of 1.1-1.5.

9. The image-processing apparatus of claim 6,
wherein said second processing section multiplies said signal intensity deviation of said second-objective pixel by a factor in a range of 0-0.75.

10. The image-processing apparatus of claim 6, further comprising:
a converting section to convert objective image signals, representing said objective pixels, to luminance signals and color-difference signals;
wherein said first processing section applies said first processing to said luminance signals, while said second processing section applies said second processing to said color-difference signals.

11. A computer program for executing operations for applying a predetermined image processing to image signals, representing a plurality of pixels included in an image, so as to output processed image signals, comprising the functional steps of:
applying a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and
applying a second processing for decreasing said signal intensity deviation or keeping said signal intensity deviation as it is to a second-objective pixel, which is included in objective pixels having a spatial frequency in a range of 0.7-3.0 lines/mm, and whose signal intensity deviation is in a range of 0-6% of said maximum signal intensity deviation.

12. The computer program of claim 11,
wherein said first processing includes a sharpness-enhancement processing, while said second processing includes a noise-reduction processing.

13. The computer program of claim 11,
wherein said first processing multiplies said signal intensity deviation of said first-objective pixel by a factor in a range of 1.1-1.5.

14. The computer program of claim 11,
wherein said second processing multiplies said signal intensity deviation of said second-objective pixel by a factor in a range of 0-0.75.

15. The computer program of claim 11, further comprising the functional step of:
converting objective image signals, representing said objective pixels, to luminance signals and color-difference signals;
wherein said first processing is applied to said luminance signals in said functional step of applying said first processing, while said second processing is applied to said color-difference signals in said functional step of applying said second processing.

16. An image-recording apparatus, comprising:
an image-processing section to apply a predetermined image processing to image signals, representing a plurality of pixels included in an input image, so as to output processed image signals; and
an image-recording section to record an output image onto a recording medium, based on said processed image signals outputted by said image-processing section;
wherein said image-processing section comprises:
a first processing section to apply a first processing for increasing a signal intensity deviation to a first-objective pixel, which is included in objective pixels having a spatial frequency in a range of 1.5-3.0 lines/mm, and whose signal intensity deviation is in a range of 30-60% of a maximum signal intensity deviation; and
a second processing section to apply a second processing for decreasing said signal intensity deviation or keeping said signal intensity deviation as it is to a second-objective pixel, which is included in objective pixels having a spatial frequency in a range of 0.7-3.0 lines/mm, and whose signal intensity deviation is in a range of 0-6% of said maximum signal intensity deviation.

17. The image-recording apparatus of claim 16,
wherein said first processing includes a sharpness-enhancement processing, while said second processing includes a noise-reduction processing.

18. The image-recording apparatus of claim 16,
wherein said first processing section multiplies said signal intensity deviation of said first-objective pixel by a factor in a range of 1.1-1.5.

19. The image-recording apparatus of claim 16,
wherein said second processing section multiplies said signal intensity deviation of said second-objective pixel by a factor in a range of 0-0.75.

20. The image-recording apparatus of claim 16,
wherein said image-processing section further comprises:
a converting section to convert objective image signals, representing said objective pixels, to luminance signals and color-difference signals; and
wherein said first processing section applies said first processing to said luminance signals, while said second processing section applies said second processing to said color-difference signals.
